(19) United States
(12) Patent Application Publication
(10) Pub. No.: US 2012/0119403 A1
(43) Pub. Date: May 17, 2012

(54) MOLDING METHOD AND METHOD FOR MANUFACTURING MOLDING PRODUCT

(75) Inventor: Toshihiko Kariya, Nagoya-shi (JP)

(73) Assignee: Mitsubishi Heavy Industries Plastic Technology Co., Ltd., Nagoya-shi, Aichi (JP)

(21) Appl. No.: 13/387,570

(22) PCT Filed: Dec. 17, 2009
(86) PCT No.: PCT/JP2009/006989

§ 371 Date: Jan. 27, 2012

(51) Int. Cl. B29C 45/16

(52) U.S. Cl. 264/46.8

(57) ABSTRACT

The molding method is composed of a primary injection molding step for molding a transparent resin at a first mold (6B) and a secondary injection molding step for molding a foamable resin between the molded transparent resin and a second mold (4).

### TECHNICAL FIELD

The present invention relates to a molding method in which a foamable resin is used as a material and a method for manufacturing a molding product.

### BACKGROUND ART

Conventionally, for the purpose of reducing the weight of a resin-made molding product and so on, a resin is mixed with a foaming agent to produce a foamable resin, which is then molded. In this instance, a phenomenon occurs in which a bundle of long- and narrowly-extending lines is formed on a surface of a molding product (hereinafter, that is referred to as “silvering phenomenon”), thereby resulting in a defective appearance of the molding product. A variety of methods have been considered for preventing the silvering phenomenon.

For example, in an injection molding method disclosed in Patent Document 1, from the start of filling a resin to its completion, the temperature of a surface of a mold in contact with a visible face of a molding product is controlled so as to be in the vicinity of a glass transition temperature of the resin. According to the injection molding method, the temperature of the surface of the mold is controlled so as to be in the vicinity of the glass transition temperature of the resin, thereby imparting fluidity to the resin. Even where bubbles burst on the visible face of the molding product, a part of the resin in which the bubbles have burst is pushed up to the surface of the mold by resin pressure, and the part is again transcribed to the surface of the mold, thereby eliminating causes for the silvering phenomenon on the visible face of the molding product.

Further, in a molding method disclosed in Patent Document 2, in place of heating and controlling the surface of the mold as disclosed in Patent Document 1, a heat insulation layer and a thin surface metal layer are provided on an inner surface of the mold. The surface of the mold is thermally insulated by the layers, and a decrease in temperature of a molten resin due to the fact that heat of the filled molten resin is deprived by the mold is suppressed by the heat insulation. Thereby, a decrease in fluidity of the resin is suppressed to improve the transcription property of the surface of the mold. The mold is constituted as described above, by which the silvering phenomenon occurring in appearance of a molding product are to be greatly reduced.

### PRIOR ART DOCUMENTS

### Patent Documents

Patent Document 1: Japanese Published Unexamined Patent Application No. 10-80932

Patent Document 2: Japanese Published Unexamined Patent Application No. 2000-33635

### SUMMARY OF THE INVENTION

### Problem to be Solved by the Invention

However, in the injection molding method disclosed in Patent Document 1, it is, in general, necessary to heat a mold with a high heat capacity, and heating the mold requires a great amount of heat. Further, a heating/cooling mold for a three-dimensional molding product requires a complicated heating-medium flow channel which is installed near a cavity surface in order to heat and which cools the cavity surface efficiently, thereby making it difficult to fabricate the mold. Still further, in the case of a large molding product, it is necessary to heat the molding product at a temperature higher than a glass transition temperature for the purpose of preventing the silvering phenomenon which will result in a defective appearance of the molding product. However, the mold is great in size and also great in heat capacity, thus resulting in a longer heating time and poor productivity.

In the molding method disclosed in Patent Document 2, it is, in general, necessary to form a film on the surface of the mold by using a high-temperature resin or ceramic. However, where the film is formed with the high-temperature resin, the film is poor in workability and also low in durability, thereby posing a problem that heat insulation is not stable. On the other hand, where the film is formed with ceramic and so on, which require sintering inside a furnace, the furnace is required to be greatly increased in size in dealing with a large-size mold. This is not practically feasible.

In addition, where a heat insulation material wears off by molding a resin which contains a very hard ingredient, measures for coping with a problem in fabricating a heat insulation mold are again taken to extend the service life of the mold. In this case, a great amount of money and time are required for repairing the mold.

The present invention has been made in view of the above problem, an object of which is to provide a molding method and a method for manufacturing a molding product in which a decrease in resin temperature caused when a foamable resin filled inside a mold on molding is in contact with the mold is suppressed, thereby eliminating the need for energy for heating the mold and also obtaining effects similar to those of a heat insulation mold even in the case of a large-size molding product, thus making it possible to improve the appearance of the foamable-resin molding product without using a heating/cooling mold or a heat insulation mold which is a special mold.

### Means for Solving the Problem

In order to solve the above problem, the present invention has proposed the following means.

The molding method of the present invention is composed of a primary injection molding step in which a transparent resin is filled into a first mold and subjected to molding and a secondary injection molding step in which a foamable resin is filled between the molded transparent resin and a second mold and subjected to molding.

Further, the method for manufacturing a molding product in the present invention is a method for manufacturing a molding product which manufactures a molding product constituted with a transparent resin and a foamable resin. The method is composed of a primary injection molding step for molding the transparent resin at a first mold and a secondary injection molding step for molding the foamable resin between the molded transparent resin and a second mold.

According to the present invention, in general, the transparent resin is formed with a material lower in heat conductivity than the mold. Therefore, the first mold can be thermally insulated easily by the transparent resin on molding the foamable resin. It is, thereby, possible to save heating energy for preventing the o silvering phenomenon, on the foamable resin which will result in a defective appearance of the molding product.

Further, every time the foamable resin is molded, the transparent resin is taken out integrally as a molding product with the foamable resin, and the transparent resin is always newly molded before the foamable resin is molded. Therefore, there is no need for attention to the durability and service life as required in a conventional film which is formed on the surface of a mold and used repeatedly and no need for regular or irregular repair of the mold for extending the service life thereof. Thus, the foamable resin on the side of the first mold can be given stable thermal insulation by the transparent resin when the foamable resin is molded.

Still further, the transparent resin permits light to pass therethrough, by which a face of the foamable resin on the side of the transparent resin is visible by eyesight to give in practice an external face of a molding product. Since the transparent resin acts as thermal insulation between the foamable resin and the first mold, it is possible to prevent the silvering phenomenon on an external face of the foamable resin (a face of the foamable resin on the side of the transparent resin) of the molding product and improve the appearance of the foamable-resin molding product without using a heating/cooling mold or a heat insulation mold which is a special mold.

Further, in the above-described molding method, it is preferable that at the secondary injection molding step, a temperature of a wall face of the second mold is cooled and controlled so as to fall within a predetermined temperature difference with respect to the temperature of the face of the transparent resin on the side of the second mold.

According to the present invention, the foamable resin on the side of the transparent resin and that on the side of the second mold are allowed to undergo substantially uniform shrinkage, thus making it possible to suppress warp occurring in the foamable resin.

Further, in the above molding method, it is more preferable that at the secondary injection molding step, the respective temperatures in which the temperature of the wall face of the second mold and the temperature of the face of the transparent resin on the side of the second mold fall within the predetermined temperature difference are cooled and controlled so as to be the glass transition temperature of the foamable resin or higher and/or the flow starting temperature or lower.

According to the present invention, the face of the foamable resin on the side of the transparent resin and the face on the side of the second mold are allowed to undergo substantially uniform shrinkage, and the foamable resin is solidified in a desired shape. Therefore, it is possible to more reliably suppress the warp resulting from a difference in shrinkage amount between both faces of the foamable resin.

Further, in the above molding method, it is more preferable that at the secondary injection molding step, after the temperature of the wall face of the second mold and the temperature of the face of the transparent resin on the side of the second mold fall within the predetermined temperature difference, the second mold is cooled at an increased speed.

According to the present invention, it is possible to suppress the warp occurring in the foamable resin and also shorten the time (tact time) necessary for manufacturing a molding product.

Further, in the above molding method, it is more preferable that after the temperature of the wall face of the second mold and the temperature of the face of the transparent resin on the side of the second mold fall within the predetermined temperature difference and before the second mold is cooled at an increased speed, the temperature of the wall face of the second mold and the temperature of the face of the transparent resin on the side of the second mold are kept within the predetermined temperature difference for a predetermined period of time.

According to the present invention, at a step where the resin is shrunk and solidified, the resin is sufficiently solidified by being kept for a predetermined period of time at such a predetermined temperature difference that will not increase a difference in shrinkage amount. It is, thereby, possible to more reliably suppress the warp occurring in the foamable resin resulting from a difference in shrinkage amount and also shorten the time necessary for manufacturing a molding product.

Further, in the above molding method, the absolute value of the temperature difference is preferably set to be 10° C.

According to the present invention, it is possible to suppress a time difference between solidification of the foamable resin on the side of the transparent resin and solidification of the foamable resin on the side of the second mold. It is also possible to prevent the warp occurring in the foamable resin at higher reproducibility by making the temperature difference be within 10° C. in which the resin is less likely to vary in a solidification state within a variance of physical properties of resins in general.

Further, in the above molding method, it is more preferable that at the secondary injection molding step, the temperature of the wall face of the second mold is cooled and controlled so as to match the temperature of the face of the transparent resin on the side of the second mold.

According to the present invention, the foamable resin on the side of the transparent resin and that on the side of the second mold are allowed to undergo substantially uniform shrinkage, thus making it possible to suppress the warp occurring in the foamable resin.

Further, in the above molding method, it is more preferable that at the secondary injection molding step, a temperature in which the temperature of the wall face of the second mold matches the temperature of the face of the transparent resin on the side of the second mold is cooled and controlled so as to be the glass transition temperature of the foamable resin or higher and/or the flow starting temperature or lower.

According to the present invention, the face of the foamable resin on the side of the transparent resin and the face on the side of the second mold are allowed to undergo substantially uniform shrinkage and the foamable resin is solidified in a desired shape. It is, thereby, possible to more reliably suppress the warp occurring in the foamable resin resulting from a difference in shrinkage amount between both faces thereof.

Further, in the above molding method, it is more preferable that at the secondary injection molding step, after the temperature of the wall face of the second mold matches the temperature of the face of the transparent resin on the side of the second mold, the second mold is cooled at an increased speed.

According to the present invention, it is possible to suppress the warp occurring in the foamable resin and also shorten the time necessary for manufacturing a molding product.

Further, in the above molding method, it is more preferable that after the temperature of the wall face of the second mold has been matched with the temperature of the face of the transparent resin on the side of the second mold and before the second mold is cooled at an increased speed, the temperature of the wall face of the second mold and the temperature of the face of the transparent resin on the side of the second mold are kept within the predetermined temperature difference for a predetermined period of time.

According to the present invention, at a step that the resin is shrunk and solidified, the resin is sufficiently solidified by being kept for the predetermined period of time at the predetermined temperature difference that will not increase a difference in shrinkage amount. It is, thereby, possible to more reliably suppress the warp occurring in the foamable resin resulting from a difference in shrinkage amount and also shorten the time necessary for manufacturing a molding product.

Further, in the above molding method, it is more preferable that at the secondary injection molding step, from when the foamable resin is injected until the foamable resin is filled all over on a face of a molding product which is in contact with the transparent resin, supply of a cooling medium for cooling the first mold is halted.

According to the present invention, where the thermal insulation effect of the transparent resin is low, it is possible to prevent heat of the filled molten resin from being dissipated to the first mold through the transparent resin. It is also possible to reliably integrate the foamable resin with the transparent resin.

Still further, in the above molding method, it is more preferable that at the secondary injection molding step, after the foamable resin has been filled all over on the face of the molding product in contact with the transparent resin, supply of the cooling medium to the first mold is started.

According to the present invention, it is possible to shorten the time necessary for manufacturing the molding product.

In addition, in the above molding method, it is preferable that at the secondary injection molding step, a temperature of the cooling medium to be supplied to the second mold is switched in multiple stages or in a stageless manner to cool and control the temperature of the cavity surface of the fixed-side mold.

According to the present invention, the temperature of the wall face of the second mold can be controlled more accurately so as to fall within a predetermined temperature range with respect to the temperature of the face of the transparent resin on the side of the second mold. Therefore, the face of the foamable resin on the side of the transparent resin and that on the side of the second mold are allowed to undergo substantially uniform shrinkage, thereby improving the reproducibility in suppressing the warp occurring in the foamable resin.

### Effects of the Invention

According to the molding method and the method for manufacturing a molding product in the present invention, a decrease in resin temperature caused when the foamable resin filled inside a mold on molding is in contact with the mold is suppressed, thereby eliminating the need for energy for heating the mold and also obtaining effects similar to those of a heat insulation mold even in the case of a large-size molding product, thus making it possible to improve the appearance of the foamable-resin molding product without using a heating/cooling mold or a heat insulation mold which is a special mold.

### BRIEF DESCRIPTION OF THE DRAWINGS

FIG. 1 is a side view which shows a molding machine of an embodiment of the present invention.

FIG. 2 is a schematic plan view of the molding machine.

FIG. 3 is a drawing which shows rotating actions of a rotating die plate of the molding machine.

FIG. 4 is a drawing which explains a second injection unit of the molding machine.

FIG. 5 is a drawing which shows a constitution for heating and cooling molds of the molding machine.

FIG. 6 is a drawing which shows examples of injection molding actions and temperature control in a molding method by the molding machine.

FIG. 7 is a schematic view which shows a state that a transparent resin is molded by the molding machine.

FIG. 8 is a schematic view which shows a state that the rotating die plate of the molding machine is turned by 180 degrees.

FIG. 9 is a schematic view which shows a state that a material of a foamable resin is injected into the molding machine.

FIG. 10 is a drawing which shows a change in temperature of a temperature sensor mounted on the transparent resin and a change in temperature of a cavity surface of a fixed-side mold with the passage of time.

FIG. 11 is a schematic view which shows a state when a material of the foamable resin is filled into the molding machine.

FIG. 12 is a drawing which shows a change in temperature at individual sites with the passage of time after the foamable resin has been injected into the molding machine.

FIG. 13 is a drawing which shows a change in temperature at individual sites with the passage of time after the foamable resin has been injected by the molding machine in a modified example of the molding method.

FIG. 14 is a drawing which shows a change in temperature at individual sites with the passage of time after the foamable resin has been injected by the molding machine in the modified of the molding method.

### MODE FOR CARRYING OUT THE INVENTION

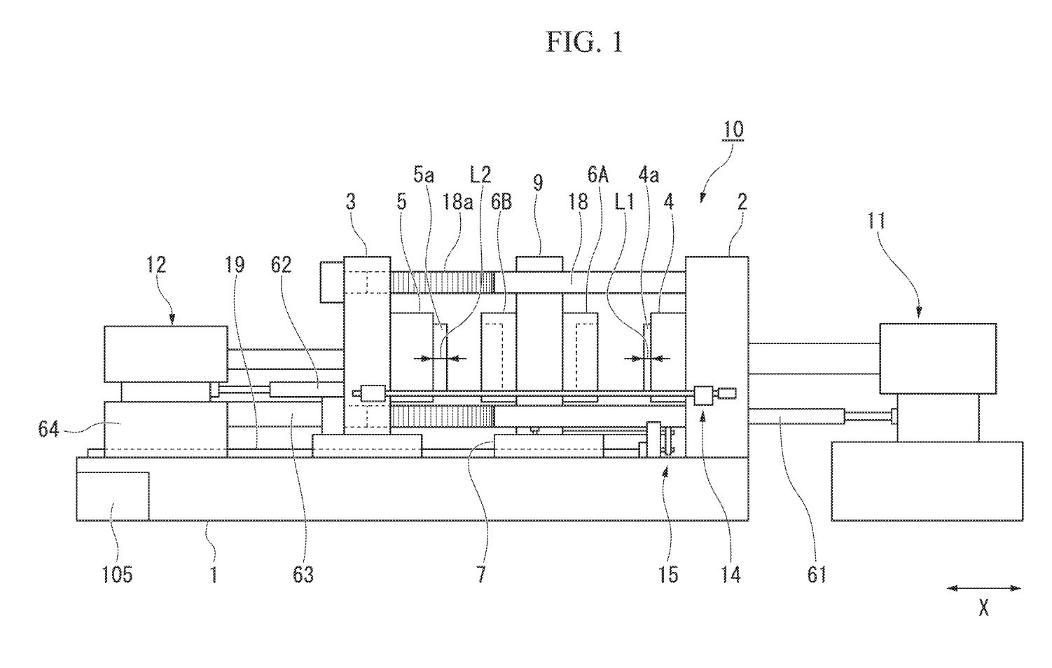

Hereinafter, a description will be given of an embodiment of the molding machine of the present invention with reference to FIG. 1 to FIG. 14. The molding machine of the present embodiment is one example of the molding machine for carrying out the molding method of the present invention, that is, equipment for molding two types of resin materials by rotating molds to be described later.

As shown in FIG. 1, a fixed die plate 2 with a fixed-side mold (a second mold) 4 is kept fixed at one end of a base 1 of a molding machine 10. A rotating die plate 9 with a rotating mold A (a first mold) (6A) and a rotating mold B (a first mold) (6B) as well as a movable die plate 3 with a movable-side mold 5 are placed on the base 1 opposite to the fixed die plate 2 so as to move freely.

The fixed-side mold 4 and the movable-side mold 5 are arranged so as to be opposed in an X direction, with the rotating die plate 9 held between them. Then, leading ends 4a, 5a, that is, parts to which the fixed-side mold 4 and the movable-side mold 5 are opposed, are designed in such a manner that each of the cross sections formed by a flat plane orthogonal to the X direction is identical in shape, and the length L2 of the leading end 5a in the X direction is longer than the length L1 of the leading end 4a in the X direction.

A turning base 7 on which the movable die plate 3 and the rotating die plate 9 are placed is guided by a guide rail 19 firmly mounted on the base 1 and allowed to move on the base 1 in the X direction.

Here, for simplifying the shape of a cavity, a description will be given, with the shape given as a flat face. However, in place of the flat face, the shape thereof may be three-dimensional as well.

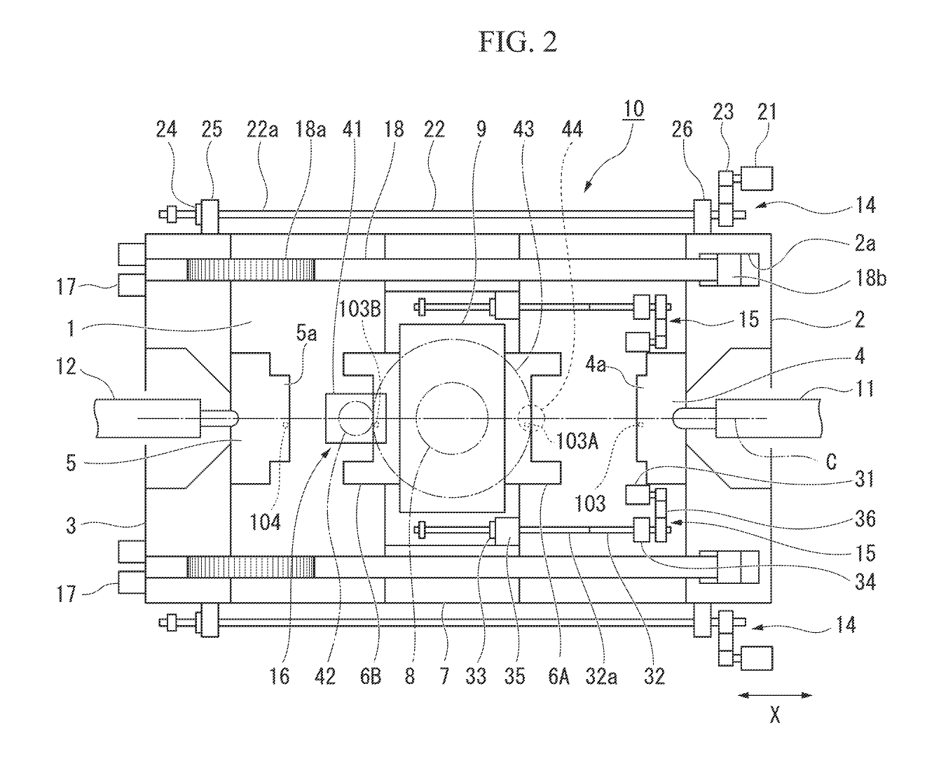

Then, a description will be given of the movable die plate 3, an opening/closing means of the rotating die plate 9, and a rotating means of the rotating die plate 9. In the following description, in the plan view of FIG. 2, regarding members of the molding machine 10 which are mounted so as to be symmetrical on the basis of a center axis line C parallel with the X direction, a reference numeral may be given to only one of each of the members.

Each of a pair of movable die plate opening/closing means 14 mounted symmetrically on both sides of the molding machine 10, with the center axis line C kept between them, is constituted with a servo motor A (21) firmly mounted on the fixed die plate 2, a ball screw shaft A (22), a supporting base 26 which is firmly mounted on the fixed die plate 2 to support the ball screw shaft A (22) so as to rotate freely by axially restricting the ball screw shaft A (22), a ball screw nut A (24) which is screwed with a ball screw 22a of the ball screw shaft A (22), a nut supporting base 25 which attaches the ball screw nut A (24) and is also firmly mounted on the movable die plate 3, and a drive train mechanism 23 which transfers rotary force of the servo motor A (21) to the ball screw shaft A (22). The pair of servo motors A (21) are operated in synchronization and the movable die plate 3 is able to open, close and move in the X direction in parallel with the fixed die plate 2.

Each of a pair of rotating die plate opening/closing means 15 installed symmetrically on both sides of the molding machine 10, with the center axis line C kept between them, is constituted with a servo motor B (31) firmly mounted on the base 1, a ball screw shaft B (32), a supporting base 34 which is firmly mounted on the base 1 and supports the ball screw shaft B (32) so as to rotate freely, a ball screw nut B (33) which is screwed with a ball screw 32a of the ball screw shaft B (32), a nut supporting base 35 which attaches the ball screw nut B (33) and is also firmly mounted on the turning base 7, and a drive train mechanism 36 which transfers the rotary force of the servo motor B (31) to the ball screw shaft B (32). The pair of servo motors B (31) are operated in synchronization, and the turning base 7 is allowed to open, close and move in parallel with the fixed die plate 2.

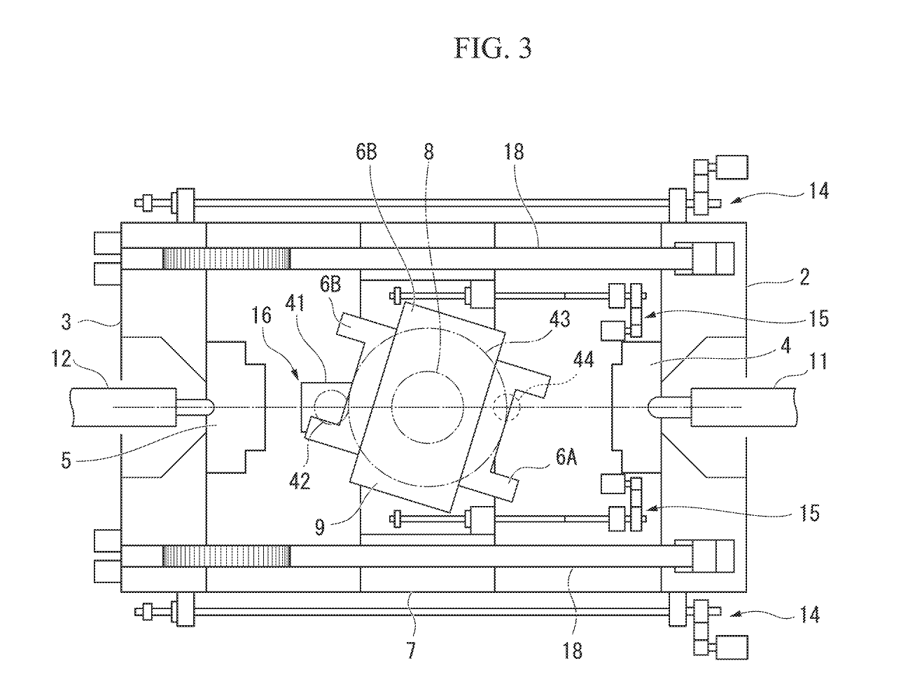

The rotating die plate 9 is placed on the turning base 7 and able to rotate around the axis line orthogonal to the surface of the base 1, as shown in FIG. 3.

As shown in FIG. 2, a rotating-die-plate rotating means 16 is a rotary drive means for rotating the rotating die plate 9 by a half turn both forward and backward or in one direction. The rotating-die-plate rotating means 16 is able to place the rotating mold A (6A) and the rotating mold B (6B) installed on both sides of the rotating die plate 9 so as to be alternately opposite to the fixed-side mold 4 or the movable-side mold 5.

The rotating die plate rotating means 16 is constituted with a servo motor C (41) attached to the turning base 7, a pinion 42 attached to the servo motor C (41), a main gear wheel 43 which is meshed with the pinion 42 and installed integrally on the rotating die plate 9, and a position-determining pin 44 for positioning by referring to a position in which a certain face of the rotating die plate 9 is opposite to the fixed die plate 2 (or the movable die plate 3) and a position which is turned by 180 degrees from the above position. A lower shaft 8 integrally formed with the rotating die plate 9 is able to rotate with respect to the turning base 7 by way of a shaft bearing (not illustrated).

Thereby, it is possible to position the rotating die plate 9 at high accuracy with respect to the turning base 7.

A hydraulic mold cramping means is to subject three sets of the die plates 2, 9, 3 to mold cramping at the same time. This means is constituted with four hydraulic cylinders 2a housed inside the fixed die plate 2, four tie bars 18 connected to a ram 18b of the cylinder 2a and installed so as to penetrate through the movable die plate 3, and four sets of split nuts 17 which are provided outside the movable die plate 3 and can be engaged with a ring groove 18a formed at the leading end of the tie bar 18.

The rotating mold A (6A) and the rotating mold B (6B) attached on both faces of the rotating die plate 9 are identical in shape, and either the rotating mold A (6A) or the rotating mold B (6B) is fitted with the fixed-side mold 4 to form a first cavity between these molds. The rotating mold A (6A) or the rotating mold B (6B) is fitted with the movable-side mold 5 to form a second cavity between the molds. The leading end 5a of the movable-side mold 5 is set so as to be longer in length in the X direction than the leading end 4a of the fixed-side mold 4. Therefore, the first cavity is constituted so as to be wider in the X direction than the second cavity.

The first injection unit 11 is installed on the side of the fixed die plate 2, while the second injection unit 12 is installed on the side of the movable die plate 3 so as to move together with movement of the movable die plate 3 when the movable die plate 3 is opened and closed.

Then, when the fixed die plate 2, the rotating die plate 9 and the movable die plate 3 are subjected to mold cramping at the same time by the hydraulic mold cramping means, the first injection unit 11 and the second injection unit 12 inject and fill respectively a material for a colored foamable resin and a material for a transparent resin into the first cavity and the second cavity in a plasticized state.

As shown in FIG. 1, the second injection unit 12 is able to move at a great stroke together with the movable die plate 3. The second injection unit 12 is placed on a sliding-type base 64 which is coupled and fixed to the movable die plate 3 by way of a coupling/fixing member 63. The sliding-type base 64 is guided by the guide rail 19 to move, by which the second injection unit 12 is allowed to move, following the movable die plate 3, without a delay in actions of the movable die plate 3.

Further, nozzle touch cylinders 61, 62 are installed respectively on the first injection unit 11 and the second injection unit 12. The nozzle touch cylinder 61 is installed so as to couple the first injection unit 11 with the fixed die plate 2, while the nozzle touch cylinder 62 is installed so as to couple the second injection unit 12 with the movable die plate 3. Then, the nozzle touch cylinders 61, 62 are shortened, by which the first injection unit 11 and the second injection unit 12 are brought closer to the fixed die plate 2 and the movable die plate 3. Thereby, nozzles at the leading ends of the first injection unit 11 and the second injection unit 12 are pressed to the fixed-side mold 4 and the movable-side mold 5 which have been attached respectively to the fixed die plate 2 and the movable die plate 3. The nozzle touch cylinder 62 is installed slidably on the sliding-type base 64 of the second injection unit 12.

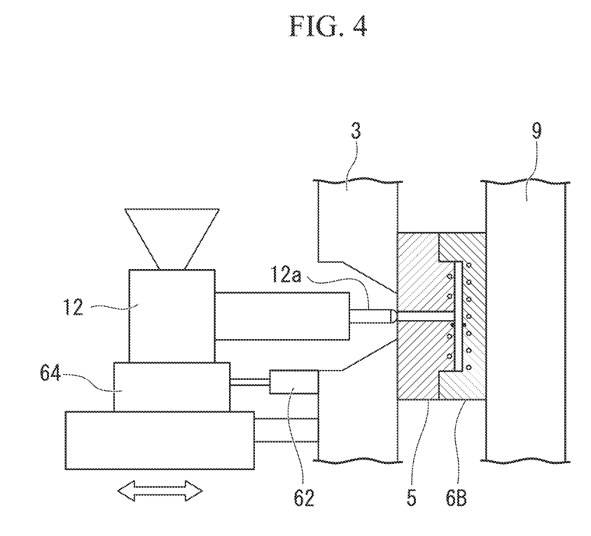

As shown in FIG. 4, in the second injection unit 12, a nozzle 12a is in contact with the movable-side mold 5 and kept in contact therewith when the mold is opened or closed. Thereby, upon completion of closing the mold and pressure elevation, a resin can be injected through the nozzle 12a, thus making it possible to inject the resin with high productivity.

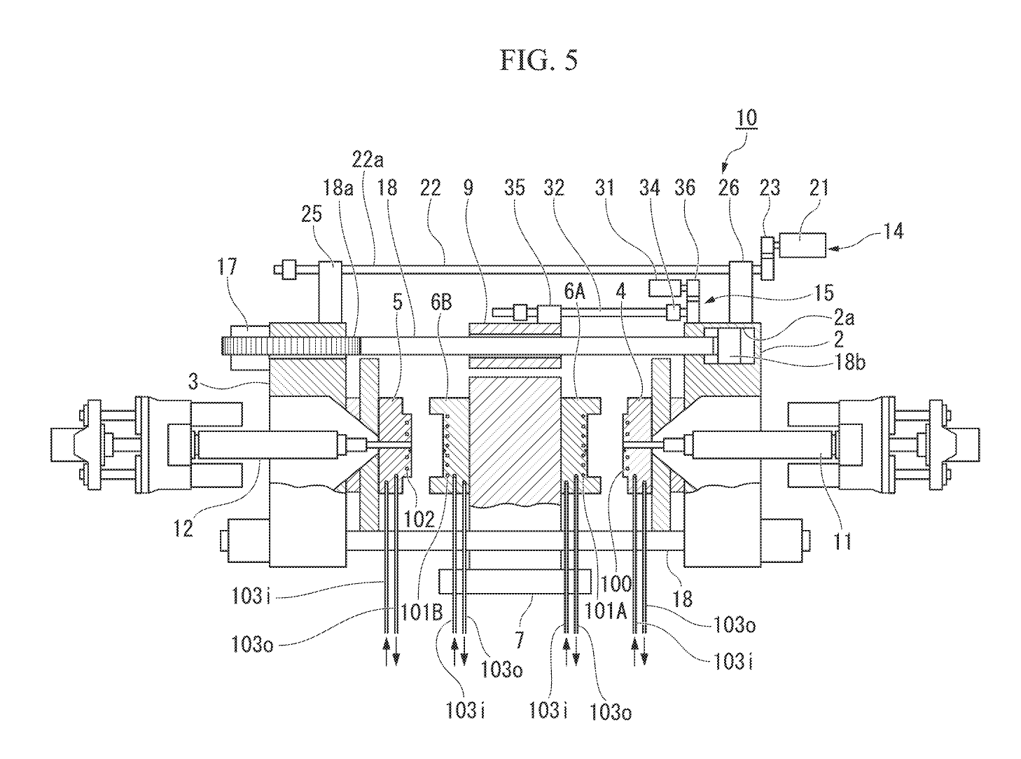

As shown in FIG. 5, on the fixed-side mold 4, the rotating mold A (6A), the rotating mold B (6B) and the movable-side mold 5, there are formed heat medium channels 100, 101A, 101B, 102 (hereinafter, referred to as “heat medium channel 100 and others”) for heating and cooling the surfaces of these molds. In order to quickly transfer heat and rapidly heat and cool the cavity surface of each mold, the heat medium channel 100 and others are formed at a position which is as close to the cavity of the mold as possible. In the present embodiment, for the purpose of improving an appearance of the transparent resin which is a primary molding product, adding surface functions and improving mold transcription properties to attain a higher added value, there is shown an example where the movable-side mold 5 is heated and cooled. However, where the primary molding product does not require a highly refined appearance, no heating/cooling molding may be required.

Further, in place of heating/cooling molding, a sophisticated film may be used to conduct insert molding for imparting a highly refined appearance or great hardness to the transparent resin.

A heating-medium supplying device for supplying a heating medium (not illustrated) and a cooling-medium supplying device for supplying a cooling medium (not illustrated) are connected to the heat medium channel 100 and others. In the present embodiment, steam and water are used as the heating medium and the cooling medium, and the heating-medium supplying device and the cooling-medium supplying device supply the heating medium and the cooling medium which are adjusted to predetermined temperatures.

In this instance, steam and water are respectively given as the heating medium and the cooling medium. However, in addition to them, the heating medium may include pressurized heated water, oil and so on, while the cooling medium may include chlorofluorocarbons, liquefied nitrogen and so on. Further, an electric heater or an electromagnetic heater may be used as a heating means in place of the heating medium.

Here, in order to supply and discharge the heating medium and the cooling medium to and from the heat medium channel 100 and others, both heat medium supplying tubes 103i, 103o are connected individually to the heat medium channel 100 and others.

As shown in FIG. 5, one ends of the heat medium supplying tubes 103i, 103o are directly connected individually to the fixed-side mold 4, the rotating mold A (6A), the rotating mold B (6B) and the movable-side mold 5. However, the heat medium supplying tubes may be connected by way of an adjustable plug or others. The heat medium supplying tubes 103i, 103o connected to the heat medium channels 101A, 101B of the rotating mold A (6A) and the rotating mold B (6B) are kept fixed to the turning base 7.

The heating-medium supplying device feeds the heating medium to the heat medium channel 100 and others by using a pump (not illustrated) to heat the fixed-side mold 4, the rotating mold A (6A), the rotating mold B (6B) and the movable-side mold 5 and circulate the heating medium which has passed through the heat medium channel 100 and others. The cooling-medium supplying device feeds the cooling medium to the heat medium channel 100 and others by using a pump (not illustrated) to cool the fixed-side mold 4, the rotating mold A (6A), the rotating mold B (6B) and the movable-side mold 5 and circulate the cooling medium which has passed through the heat medium channel 100 and others. The heating-medium supplying device and the cooling-medium supplying device opens and closes an opening/closing valve (not illustrated), thereby controlling supply of the heating medium and cooling medium. The opening/closing valve is controlled for opening/closing operation on the basis of a predetermined program by a control device 105 of the molding machine 10 (refer to FIG. 1).

As shown in FIG. 2, the fixed-side mold 4, the rotating mold A (6A), the rotating mold B (6B), and the movable-side mold 5 are respectively provided with mold temperature sensor 103, 103A, 103B, 104 for determining a temperature of each cavity surface (each wall face). That is, for example, a temperature determined by the mold temperature sensor 103 is given as a temperature of the cavity surface and so on, of the fixed-side mold 4.

Signals of the temperatures detected by the mold temperature sensors 103, 103A, 103B, 104 are sent to the control device 105 of the molding machine 10. The control device 105 takes control on the basis of a predetermined computer program, allows the opening/closing valve (not illustrated) to open and close in accordance with temperatures detected by the mold temperature sensors 103, 103A, 103B, 104, thereby controlling supply of the heating medium and the cooling medium to the heat medium channel 100 and others.

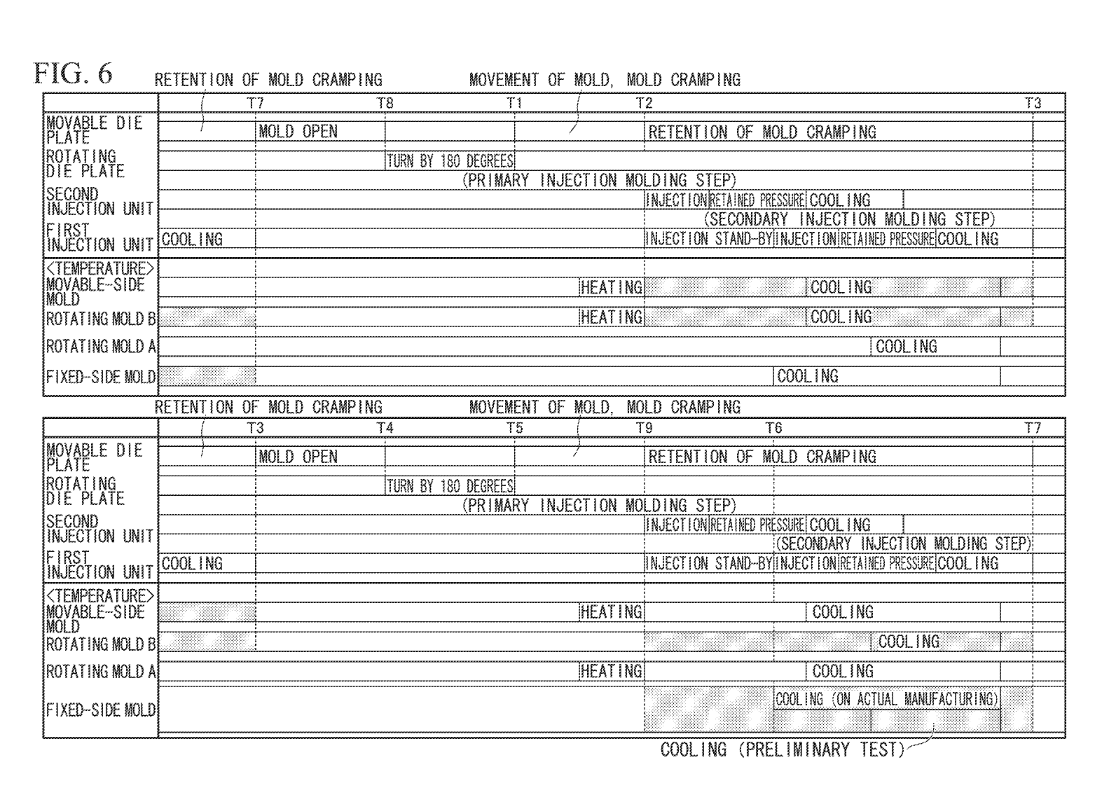

Then, with reference to FIG. 6, a description will be given of steps of the molding method (the method for manufacturing a molding product) by the molding machine 10 of the present embodiment. The molding method is composed of the primary injection molding step in which the transparent resin is subjected to injection molding at the second cavity on the side of the second injection unit 12 and the secondary injection molding step in which the foamable resin is subjected to injection molding at the first cavity on the side of the first injection unit 11, and these steps are repeated sequentially.

Hereinafter, a description will be given at first in a state that the rotating mold B (6B) of the rotating die plate 9 is arranged on the side of the movable-side mold 5. At the columns of temperatures in FIG. 6, both of the molds which are shaded and those which are not shaded are paired respectively at corresponding periods of time to form cavities.

In manufacturing a molding product, the primary injection molding step as shown hereinafter is conducted in advance, and a temperature sensor is attached to a molded transparent resin and, thereafter, a preliminary test is carried out to conduct the secondary injection molding step.

At first, in accordance with procedures to be shown hereinafter in detail, at the primary injection molding step, the transparent resin is molded at the second cavity formed by fitting the rotating mold B (6B) with the movable-side mold 5.

The transparent resin used in the present invention preferably includes any one of resins which are high in light transmission, that is, polycarbonate, polymethyl methacrylate, polystyrene, polyethylene terephthalate, polyether sulfone, alicyclic olefin resin, alicyclic acrylic resin, norbornene-based heat-resistant transparent resin, cyclic olefin copolymer, polymethacrylic acid ester resin, epoxy resin and polyvinyl chloride.

The control device 105 allows the rotating die plate 9 and the movable die plate 3 to move closer to the fixed die plate 2 at timing T1 to close a mold and, thereafter, conducts mold cramping by the hydraulic cylinder 2a. Further, the control device 105 opens and closes an opening/closing valve to supply the heating medium to the heat medium channels 101B, 102 by the heating-medium supplying device, thereby heating respectively the rotating mold B (6B) and the movable-side mold 5 to a predetermined temperature.

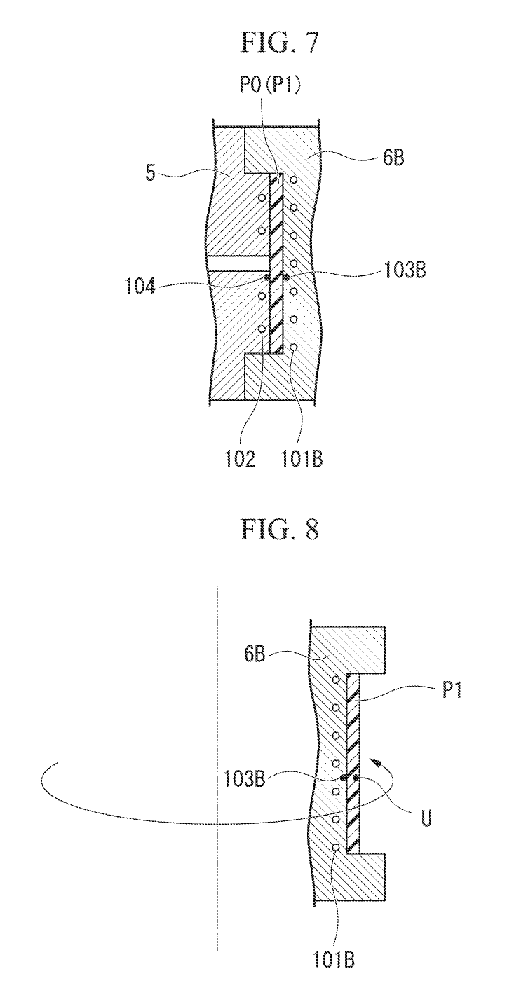

As shown in FIG. 7, at timing T2 after completion of the mold cramping, a material PO for a molten transparent resin P1 is injected and filled from the second injection unit 12 into the second cavity which is formed with the rotating mold B (6B) and the movable-side mold 5. After completion of the injection and filling, a state in which a certain pressure is applied to the material PO is maintained for a certain period of time.

Then, the cooling-medium supplying device is used to supply the cooling medium to the heat medium channels 101B, 102, thereby cooling the rotating mold B (6B) and the movable-side mold 5 to a flow starting temperature or lower of the material P0. Thereby, the material P0 is solidified to form the transparent resin P1. Thereafter, supply of the cooling medium to the heat medium channels 101B, 102 is halted.

The flow starting temperature of a resin is a temperature in which fluidity is exhibited by an external force while raising the temperature of the resin by heating. For example, the flow starting temperature is a temperature in which a melt viscosity indicates 48000 poise (4800 Pa·s) when a Koka-type flow tester (constant-load orifice-type flow tester) CFT-500 type made by Shimadzu Corporation is used and a resin heated at a temperature elevation speed of 4° C./minute is subjected to extrusion at loads of 100 kgf/cm² (9.81 MPa) through a nozzle which is 1 mm in inner diameter and 10 mm in length.

At timing T3 after the passage of time during which the transparent resin P1 is solidified, the movable die plate 3 and the turning base 7 which carries the rotating die plate 9 are allowed to move to open the mold, and an interval between each of the die plates 2, 9, 3 is sufficiently kept. At timing T4, as shown in FIG. 8, the rotating die plate 9 with the rotating mold B (6B) is turned by 180 degrees. In this instance, a temperature sensor U is attached to a face of the transparent resin P1 on the side which is spaced away from the rotating mold B (6B), thereby determining the temperature of the face.

Then, at timing T5, the movable die plate 3 and the rotating die plate 9 are allowed to close the die again.

Then, in accordance with the procedures to be shown hereinafter in detail, at the secondary injection molding step, the foamable resin is molded at the first cavity formed by fitting the rotating mold B (6B) with the fixed-side mold 4.

Various types of known foaming agents can be used as the foaming agent used in the present invention. The foaming agent may be any one of a solvent-type foaming agent, a decomposition-type foaming agent and a physical foaming agent.

The solvent-type foaming agent is such a substance that is in general fed from a hopper of an injection molding machine or a cylinder part, dissolved or absorbed into the molten thermoplastic resin described above and, thereafter, volatilized inside the cavity of a mold, thereby functioning as a foaming agent. For example, this type of foaming agent includes aliphatic hydrocarbons lower in boiling point such as propane, butane, neopentane, heptane, isohexane, hexane, isoheptane and heptane as well as fluorine-containing hydrocarbons lower in boiling point represented by chlorofluorocarbons.

The decomposition-type foaming agent is such a compound that is mixed in advance with the thermoplastic resin, supplied to the injection molding machine and dissolved under cylinder-temperature conditions of the injection molding machine, thereby generating a gas such as carbon dioxide and nitrogen gas. The decomposition-type foaming agent may include an inorganic foaming agent and an organic foaming agent. Alternatively, an organic acid such as citric acid which promotes generation of a gas and a metallic salt of organic acid such as sodium citrate may be added as a foaming auxiliary agent and used in combination with the decomposition-type foaming agent.

Examples of the decomposition-type foaming agent include the following compounds.

(i) Inorganic foaming agents: sodium bicarbonate, sodium carbonate, ammonium bicarbonate, ammonium carbonate and ammonium nitrite
(ii) Organic foaming agents:
(a) N-nitroso compounds: N,N′-dinitrosoterephthalamide, N,N′-dinitrosopentamethylenetetramine 40
(b) Azo compounds: azodicarbonamide, azobisisobutyronitrile, azocyclohexylnitrile, azodiaminobenzene, barium azodicarboxylate
(c) Sulfonyl hydrazide compounds: benzenesulfonyl hydrazide, toluenesulfonyl hydrazide, p,p′-oxybis(benzenesulfonyl hydrazide), diphenylsulfone-3,3′-disulfonylhydrazide
(d) Azide compounds: calcium azide, 4,4′-diphenyldisulfonyl azide, p-toluenesulfonyl azide.

The physical foaming agent includes any generally used physical foaming agents and they can be used without any particular problem. Inactive gases such as carbon dioxide, nitrogen, argon, helium, and neon may be used. Among these gases, most preferable are carbon dioxide, nitrogen and argon which are inexpensive and extremely low in terms of environmental pollution and risk of fire. Further, the physical foaming agent can be used in any state, a liquid state, a supercritical state or a gaseous state.

These foaming agents may be used solely or in combinations of two or more. In addition, the foaming agent may be mixed in advance with the thermoplastic resin or may be fed on injection molding from a midstream part of the cylinder. Further, the foaming agent may be mixed in advance with the foaming auxiliary agent or others to make a master batch, which may be then mixed with the thermoplastic resin.

An additive amount of the foaming agent is selected, with consideration given to an amount of gas generated from the foaming agent and a desirable foaming rate, depending on the required physical properties of a foamed molding body. The foaming agent is added usually in a range from 0.1 to 6 parts by weight with respect to 100 parts by weight of the thermoplastic resin and preferably in a range from 0.5 to 3 parts by weight. Where the amount of the foaming agent is in the above range, bubbles are uniform in diameter and the bubbles are also dispersed evenly to obtain the foamed molding body excellent in appearance.

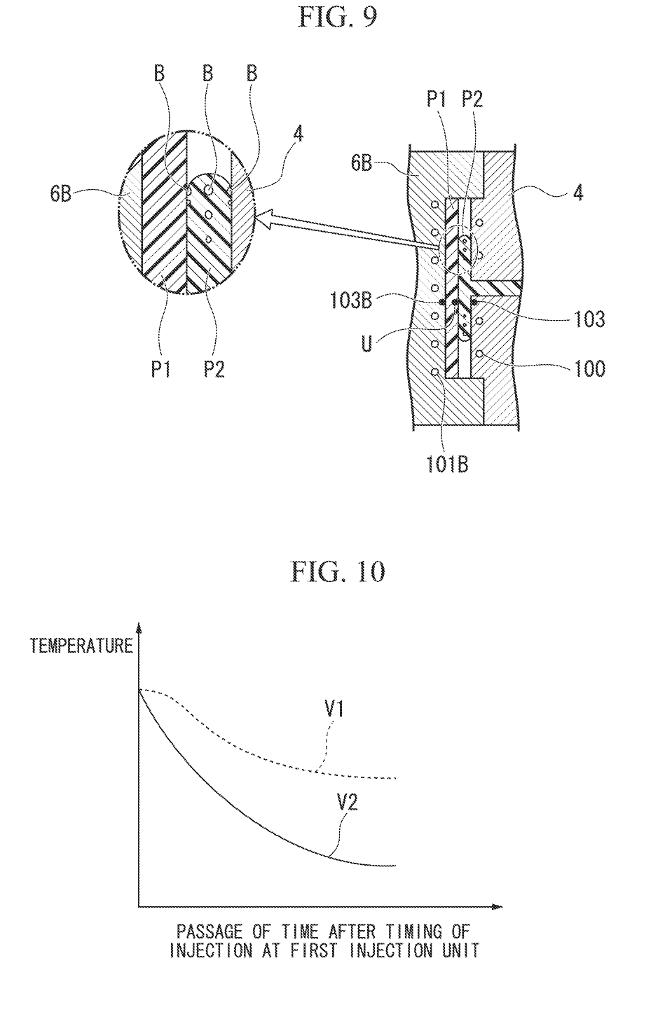

As shown in FIG. 9, a material P2 for a foamable resin which has been molten from the first injection unit 11 is heated to a temperature higher than a flow starting temperature of the foamable resin and injected into the first cavity formed by the transparent resin P1 which has already been molded and affixed onto the rotating mold B (6B) and by the fixed-side mold 4.

Since a decrease in pressure is found at the leading end of the injected material P2, bubbles B in the material P2 burst. The bubbles B occur also on the surface of the material P2. However, when the molten material P2 is pressed by injection pressure of the first injection unit 11 to the cavity surface of the transparent resin P1 on the side of the fixed-side mold 4 which is on an external face of a molding product, a decrease in temperature of the material P2 is suppressed by the thermal insulation effect of the transparent resin. Thereby, a decrease in fluidity of the material P2 is delayed and the material P2 is deformed by the injection pressure to result in disappearance of the bubbles B. The material P2 is prevented from the silvering phenomenon on the surface thereof.

In this instance, as shown in FIG. 10, a temperature V1 and a temperature V2 are respectively determined by the temperature sensor U attached to the transparent resin P1 and the mold temperature sensor 103. In general, since the transparent resin P1 is lower in heat conductivity than the fixed-side mold 4, the temperature V2 is lowered earlier than the temperature V1.

Further, when injection is performed continuously from the first injection unit 11, as shown in FIG. 11, the material P2 of the foamable resin is filled all over on a contact surface P3 with the transparent resin P1, and the transparent resin P1 is integrated with the material P2 on the contact surface P3. On molding the foamable resin, there is conducted a known core back step in which the rotating die plate 9 is allowed to move with respect to the fixed-side mold 4 so as to open the mold.

In this instance, after a state that a certain pressure has been applied to the material P2 is maintained for a certain period of time, the cooling-medium supplying device is used to start supply of the cooling medium to the heat medium channels 101 B, 100. Thereby, the rotating mold B (6B) and the fixed-side mold 4 are cooled to a temperature equal to or lower than the flow starting temperature of the foamable resin P4 to solidify the material P2, thus molding a foamable resin P4.

Thereby, there is molded a molding product (a two-component molding product) P which is constituted by integrating the transparent resin P1 with the foamable resin P4.

As described so far, after determination of the temperature V1 by the temperature sensor U, the molding product P is actually manufactured. The following steps are similar to those of the preliminary test except that the primary injection molding step and the secondary injection molding step are conducted repeatedly without attaching the temperature sensor U to the transparent resin P1 and the fixed-side mold 4 is controlled for temperature on the basis of the determined temperature V1.

A resin used at the primary injection molding step of the preliminary test is most preferably the same type as a transparent resin used in actual manufacturing. However, where the resin used at the primary injection molding step of the preliminary test is softened by a foamable resin high in temperature at the secondary injection molding step of the preliminary test to result in a failure in keeping the temperature sensor U and a subsequent difficulty in determining a temperature, a resin higher in heat resistance than the transparent resin may be used.

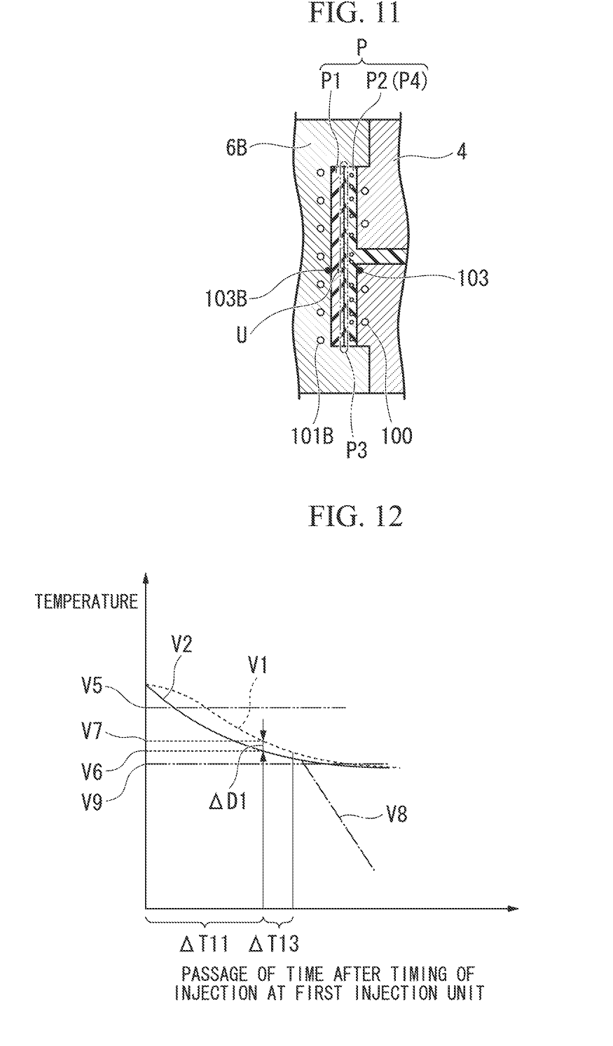

A description will be given only for steps involved in actual manufacturing of the molding product P which are different from steps of the preliminary test. At the secondary injection molding step, the control device 105 injects the material P2 for the foamable resin P4 into the first cavity from the first injection unit 11 at timing T6. Thereafter, as shown in FIG. 12, the temperature V2 determined by the mold temperature sensor 103 is cooled and controlled so as to fall within a temperature difference ΔD1 with respect to the temperature V1 previously determined by the temperature sensor U within predetermined time ΔT11 from the timing T6.

Cooling controlled by the control device 105 is attained by controlling a cooling speed of the fixed-side mold 4 by supplying at an appropriate flow rate the cooling medium appropriate in temperature to the heat medium channel 100 of the fixed-side mold 4. On the other hand, in the meantime, the cooling medium may not be supplied to the heat medium channel 101B.

The predetermined time ΔT11 is decided, whenever necessary, depending on tact time for manufacturing the molding product P. Further, it is preferable that after the temperature difference ΔD1 has been attained, during a period of predetermined time ΔT13, the temperature V2 determined by the mold temperature sensor 103 is cooled and controlled so as to fall within the temperature difference ΔD1 with respect to the temperature V1 previously determined by the temperature sensor U. Still further, it is preferable that the absolute value of the temperature difference ΔD1 is set to be 10° C.

At timing T7 after the material P2 of the foamable resin P4 has been solidified, when the movable die plate 3 and the turning base 7 which carries the rotating die plate 9 are allowed to move to open the mold, and an interval between each of the die plates 2, 9, 3 is sufficiently kept, an ejector (not illustrated) is used to take out the molding product P affixed to the rotating mold B (6B). Then, at timing T8, the rotating die plate 9 is turned by 180 degrees.

Further, as shown in FIG. 6, at timing T9 between the timing T5 and the timing T6, the second injection unit 12 is used to inject the material P0 of the transparent resin P1 into the second cavity formed by fitting the rotating mold A (6A) with the movable-side mold 5.

As described above, the molding machine 10 continuously manufactures the molding product P by turning the rotating die plate 9 to switch the rotating molds 6A, 6B which constitute the second cavity and the first cavity.

The fixed-side mold 4 is cooled and controlled at the secondary injection molding step, by which the face of the transparent resin P1 on the side of the fixed-side mold 4 is considered to undergo a change in temperature on actual manufacturing. In this instance, in a state that the fixed-side mold 4 has been cooled and controlled as described above, a temperature of the face of the transparent resin P1 on the side of the fixed-side mold 4 is newly determined at the secondary injection molding step. The newly determined temperature may be given as the temperature V1 to cool and control the fixed-side mold 4.

Further, the temperature may be repeatedly determined when such a necessity is raised.

As described so far, according to the molding method and the method for manufacturing a molding product in the present embodiment, in general, the transparent resin is formed with a material lower in heat conductivity than a mold. Therefore, on molding the foamable resin P4, the foamable resin P4 on the side of the rotating mold B (6B) is thermally insulated easily by the transparent resin P1 and a decrease in resin temperature when the foamable resin P4 is in contact with the mold is suppressed. Thereby, the need for energy for heating the mold is eliminated and effects similar to those of a heat insulation mold can be obtained also for a large-size molding product.

Further, every time the foamable resin P4 is molded, the transparent resin P1 is taken out integrally with the foamable resin P4 as the molding product P and always newly molded before the foamable resin P4 is molded. Therefore, there is no need for attention to the durability and service life as required in a conventional film which is formed on the surface of a mold and used repeatedly and no need for regular or irregular repair of the mold for extending the service life thereof. Thus, the foamable resin P4 on the side of the rotating mold B (6B) can be given stable thermal insulation by the transparent resin P1 when the foamable resin P4 is molded.

Still further, the face of the foamable resin P4 on the side of the transparent resin P1 is visible by eyesight because of light permeability of the transparent resin P1. However, since the transparent resin P1 acts as thermal insulation between the foamable resin P4 and the rotating mold B (6B), it is possible to prevent the silvering phenomenon on the face of the foamable resin P4 on the side of the transparent resin P1 and improve the appearance of the foamable resin P4.

Then, at the secondary injection molding step, the temperature of the cavity surface of the fixed-side mold 4 is cooled and controlled so as to fall within the temperature difference ΔD1 with respect to the temperature of the face of the transparent resin P1 on the side of the fixed-side mold 4. Therefore, the foamable resin P4 on the side of the transparent resin P1 and that on the side of the fixed-side mold 4 are allowed to undergo substantially uniform shrinkage, thus making it possible to suppress the warp occurring in the foamable resin P4.

Further, after the temperature difference ΔD1 has been attained, the temperature of the cavity surface of the fixed-side mold 4 is kept also for predetermined time ΔT13 so as to fall within the temperature difference ΔD1 with respect to the temperature of the face of the transparent resin P1 on the side of the fixed-side mold 4. Then, at a step where the resin is shrunk and solidified, the resin is sufficiently solidified by being kept for a predetermined period of time at such a predetermined temperature difference that will not increase the difference in shrinkage amount. Thereby, it is possible to suppress the warp occurring in the foamable resin resulting from a difference in shrinkage amount.

Still further, an absolute value of the temperature difference ΔD1 is set to be 10° C., by which there is further suppressed a time difference between solidification of the foamable resin P4 on the side of the transparent resin P1 and solidification of the foamable resin P4 on the side of the fixed-side mold 4. It is also possible to reliably prevent the warp occurring in the foamable resin P4 at higher reproducibility by making a temperature difference within 10° C. in which the resin is less likely to vary in a solidification state within a variance of physical properties of resins in general.

In addition, after the material P2 of the foamable resin P4 is filled all over on the contact surface P3 of the molding product P with the transparent resin P1, the cooling medium is supplied to the fixed-side mold 4 in an increased amount. Alternatively, supply of the cooling medium lower in temperature is started, thus making it possible to shorten the time necessary for cooling the molding product P down to a temperature in which the molding product P can be taken out and also shorten the time necessary for manufacturing the molding product P.

Then, the transparent resin P1 is formed by injection molding. Thus, even where the face of the foamable resin P4 to be integrated with the transparent resin P1 is a face that is complicated in shape such as a free curved surface, the transparent resin P1 can be formed in accordance with the shape of the face concerned.

Further, it is acceptable that the foamable resin P4 is molded in a state that the molded transparent resin P1 is not decreased in temperature down to ordinary temperature but decreased in temperature to such an extent that the transparent resin P1 is solidified so as to maintain the shape thereof. Thereby, the temperature of the transparent resin P1 itself is elevated to improve the effect of the material P2 for suppressing the decrease in temperature (thermal insulation effect). Then, it is possible to further improve the appearance of the foamable resin P4 by preventing the silvering phenomenon on the face of the foamable resin P4 on the side of the transparent resin P1. It is also possible to improve a compatibility of the transparent resin P1 with the foamable resin P2 and improve the adhesion.

The molding product P is provided with the transparent resin P1 on the surface of the foamable resin P4. Therefore, as with a case where a clear coat is applied to the surface of the foamable resin P4, it is possible to give a higher quality impression to an appearance of the molding product P on the side of the transparent resin P1.

In the present embodiment, as will be described hereinafter, the temperature of the cavity surface of the fixed-side mold 4 (the temperature determined by the mold temperature sensor 103) may be controlled in various ways at the secondary injection molding step.

For example, as shown in FIG. 12, the respective temperatures V6, V7 in which the temperature of the cavity surface of the fixed-side mold 4 (the temperature V2 determined by the mold temperature sensor 103) and the previously determined temperature of the face of the transparent resin P1 on the side of the fixed-side mold 4 (the temperature V1 determined by the temperature sensor U) fall within the previously described temperature difference ΔD1, may be cooled and controlled so as to be higher than the glass transition temperature V9 of the foamable resin P4 or lower than a flow starting temperature V5. It is more preferable that the respective temperatures V6, V7 which fall within the previously described temperature difference ΔD1 are cooled and controlled so as to be higher than the glass transition temperature V9 of the foamable resin P4 and lower than the flow starting temperature V5.

According to the above-described control, in a temperature range higher than the glass transition temperature which is a temperature range in which the resin undergoes shrinkage and lower than the flow starting temperature, the foamable resin P4 on the side of the transparent resin P1 and the foamable resin on the side of the fixed-side mold 4 undergo substantially uniform shrinkage, and the foamable resin P4 is solidified in a desired shape. It is, thereby, possible to more reliably suppress the warp occurring in the foamable resin P4.

Further, after the temperature of the cavity surface of the fixed-side mold 4 and the previously determined temperature of the face of the transparent resin P1 on the side of the fixed-side mold 4 fall within the temperature difference ΔD1, the cooling medium is supplied to the heat medium channel 100 in an increased amount or supply of the cooling medium lower in temperature is started. Thereby, the fixed-side mold 4 is cooled at an increased speed, and, as shown by the temperature V8 in FIG. 12, the temperature of the cavity surface of the fixed-side mold 4 may be decreased rapidly from the temperature V2.

According to the above-described control, it is possible to suppress the warp occurring in the foamable resin P4 and shorten the time necessary for manufacturing the molding product P.

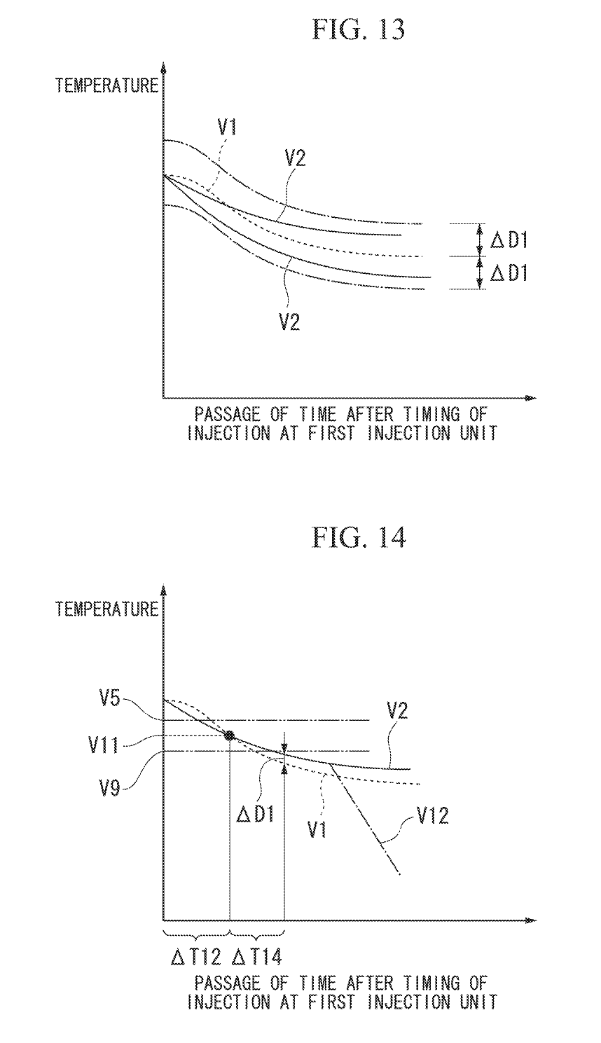

Then, in the present embodiment, as shown in FIG. 13, at the secondary injection molding step subsequent to the timing T6 in which the resin is injected from the first injection unit 11, the temperature of the cavity surface of the fixed-side mold 4 and the previously determined temperature of the face of the transparent resin P1 on the side of the fixed-side mold 4 may be controlled so as to fall within the temperature difference ΔD1, for example, until each of the temperatures becomes room temperature.

According to the above-described control, it is possible to more reliably suppress the warp occurring in the foamable resin P4.

Further, in the present embodiment, as shown in FIG. 14, at the secondary injection molding step, the temperature of the cavity surface of the fixed-side mold 4 (the temperature V2 determined by the mold temperature sensor 103) may be cooled and controlled so as to match the previously determined temperature of the face of the transparent resin P1 on the side of the fixed-side mold 4 (the temperature V1 determined by the temperature sensor U) at a temperature V11 within a predetermined time ΔT12.

According to the above-described control, the foamable resin P4 on the side of the transparent resin P1 and that on the side of the fixed-side mold 4 are allowed to undergo substantially uniform shrinkage, thus making it possible to suppress the warp occurring in the foamable resin P4.

Still further, the temperature V11 may be cooled and controlled so as to be higher than the glass transition temperature V9 of the foamable resin P4 or lower than the flow starting temperature V5. In addition, it is more preferable that the temperature V11 is cooled and controlled so as to be higher than the glass transition temperature V9 of the foamable resin P4 and also lower than the flow starting temperature V5.

According to the above-described control, the foamable resin P4 on the side of the transparent resin P1 and that on the side of the fixed-side mold 4 are allowed to undergo substantially uniform shrinkage, and the foamable resin P4 is solidified in a desired shape. It is, thus, possible to more reliably suppress the warp occurring in the foamable resin.

Then, after the temperature of the cavity surface of the fixed-side mold 4 matches the previously determined temperature of the face of the transparent resin P1 on the side of the fixed-side mold 4 at the temperature V11, the fixed-side mold 4 is cooled at an increased speed. Additionally, as shown by the temperature V12 in the drawing, the temperature of the cavity surface of the fixed-side mold 4 may be decreased rapidly from the temperature V2.

According to the above-described control, it is possible to suppress the warp occurring in the foamable resin P4 and also shorten the time necessary for manufacturing the molding product P.

In addition, after the temperature of the cavity surface of the fixed-side mold 4 matches the previously determined temperature of the face of the transparent resin P1 on the side of the fixed-side mold 4 at the temperature V11, the temperature of the cavity surface of the fixed-side mold 4 is kept for predetermined time ΔTI 4 so as to fall within the temperature difference ΔD1 with respect to the temperature of the face of the transparent resin P1 on the side of the fixed-side mold 4. Thereby, at a step that the resin is shrunk and solidified, the resin is solidified by being kept for a predetermined period of time at such a predetermined temperature difference that will not increase the difference in shrinkage amount. Thereby, it is possible to suppress the warp occurring in the foamable resin resulting from a difference in shrinkage amount.

A description has been so far given of the embodiment of the present invention with reference to the drawings. A specific constitution shall not be restricted to the present embodiment, and a change in constitution not departing from the gist of the present invention will be included in the present invention.

Further, in the above embodiment, prior to repeated manufacturing of the molding product P, the temperature of the face of the transparent resin P1 on the side of the fixed-side mold 4 is to be determined by conducting the preliminary test. However, the temperature may be determined through analysis by utilizing a computer-based simulation of thermal fluid and the like.

Still further, in the above embodiment, at the timing T6 after mold cramping at the secondary injection molding step of the preliminary test, in a state that supply of the heating medium and the cooling medium to the heat medium channels 100, 101B is halted, there is determined the temperature V1 on the face of the transparent resin P1 on the side of the fixed-side mold 4 and, then, on actual manufacturing of the molding product P, the temperature of the cavity surface of the fixed-side mold 4 is cooled and controlled in accordance with the temperature V1. However, where the transparent resin P1 is thin and so on, and where thermal insulation by the transparent resin P1 is considered to be relatively less effective, in such a manner that the temperature of the fixed-side mold 4 corresponds to a change in temperature of the face of the transparent resin P1 on the side of the fixed-side mold which has been understood by the preliminary test or analysis, the temperature of the cooling medium to be supplied to the fixed-side mold 4 is switched in multiple stages or in a stageless manner by using a cooling control device (not illustrated) and, thereby, the temperature of the cavity surface of the fixed-side mold 4 may be cooled and controlled.

### INDUSTRIAL APPLICABILITY

The present invention relates to a molding method which is composed of a primary injection molding step in which a transparent resin is filled into a first mold and subjected to molding and a secondary injection molding step in which a foamable resin is filled between the molded transparent resin and a second mold and subjected to molding. According to the present invention, it is possible to improve the appearance of a foamable-resin molding product.

### DESCRIPTION OF REFERENCE NUMERALS

4: Fixed-side mold (second mold)
6A: Rotating mold A (first mold)
6B: Rotating mold B (first mold)
ΔD1: Temperature difference
P: Molding product
P1: Transparent resin
P3: Contact surface
P4; Foamable resin

1. A molding method comprising:
a primary injection molding step in which a transparent resin is filled into a first mold and subjected to molding; and
a secondary injection molding step in which a resin is filled between the transparent resin and the second mold and subject to molding in a state that the transparent resin molded at the primary injection molding step is not decreased in temperature down to ordinary temperature but is decreased in temperature to such an extent that the transparent resin is solidified so as to keep the shape thereof, wherein
the transparent resin molded at the primary injection molding step is used as an insulation material at the second mold which is taken out as a molding product molded integrally with the resin at the secondary injection molding step, every time the resin at the secondary injection molding step is molded, and always newly molded before the resin at the secondary injection molding step is molded.

2. The molding method according to claim 1, wherein at the secondary injection molding step,
the resin which is filled between the transparent resin and the second mold is a foamable resin.

3. The molding method according to claim 1, wherein at the secondary injection molding step,
a temperature of a wall face of the second mold is cooled and controlled so as to fall within a temperature difference of 10° C. with respect to a temperature of a face of the transparent resin on the side of the second mold.

4. The molding method according to claim 3, wherein the respective temperatures in which the temperature of the wall face of the second mold and the temperature of the face of the transparent resin on the side of the second mold have fallen within the predetermined temperature difference are cooled and controlled so as to be a glass transition temperature of the foamable resin or higher and/or a flow starting temperature or lower.

5. The molding method according to claim 3, wherein at the secondary injection molding step,
after the temperature of the wall face of the second mold and the temperature of the face of the transparent resin on the side of the second mold have fallen within the predetermined temperature difference, the second mold is cooled at an increased speed.

6. The molding method according to claim 5, wherein after the temperature of the wall face of the second mold and the temperature of the face of the transparent resin on the side of the second mold have fallen within the predetermined temperature and before the second mold is cooled at an increased speed, the temperature of the wall face of the second mold and the temperature of the face of the transparent resin on the side of the second mold are kept within the predetermined temperature difference for a predetermined period of time.

7. The molding method according to claim 1, wherein the transparent resin is any one of polycarbonate, polymethyl methacrylate, polyethylene terephthalate, polyether sulfone, alicyclic olefin resin, alicyclic acrylic resin, norbornene-based heat-resistant transparent resin, cyclic olefin copolymer and epoxy resin.

8. The molding method according to claim 1, wherein at the secondary injection molding step,
the temperature of the wall face of the second mold is cooled and controlled so as to match the temperature of the face of the transparent resin on the side of the second mold.

9. The molding method according to claim 8, wherein at the secondary injection molding step,
a temperature in which the temperature of the wall face of the second mold matches the temperature of the face of the transparent resin on the side of the second mold is cooled and controlled so as to be a glass transition temperature of the foamable resin or higher and/or a flow starting temperature or lower.

10. The molding method according to claim 8, wherein at the secondary injection molding step,
after the temperature of the wall face of the second mold has been matched with the temperature of the face of the transparent resin on the side of the second mold, the second mold is cooled at an increased speed.

11. The molding method according to claim 10, wherein after the temperature of the wall face of the second mold has been matched with the temperature of the face of the transparent resin on the side of the second mold and before the second mold is cooled at an increased speed, the temperature of the wall face of the second mold and the temperature of the face of the transparent resin on the side of the second mold are kept within the predetermined temperature difference for a predetermined period of time.

12. The molding method according to claim 2, wherein at the secondary injection molding step,
from when the foamable resin is injected until the foamable resin is filled all over on a face of a molding product which is in contact with the transparent resin, supply of a cooling medium for cooling the first mold is halted.

13. The molding method according to claim 12, wherein at the secondary injection molding step,
after the foamable resin has been filled all over on the face of the molding product which is in contact with the transparent resin, supply of the cooling medium to the first mold is started.

14. The molding method according to claim 1, wherein at the secondary injection molding step,
a temperature of the cooling medium to be supplied to the second mold is switched in multiple stages or in a stageless manner to cool and control the temperature of the wall face of the second mold.

15. A method for manufacturing a molding product which manufactures a molding product constituted with a transparent resin and a foamable resin, the method for manufacturing a molding product comprising:
a primary injection molding step for molding the transparent resin at a first mold; and
a secondary injection molding step for molding the foamable resin between the molded transparent resin and a second mold.
